(19) United States
(12) Patent Application Publication
(10) Pub. No.: US 2010/0107783 A1
(43) Pub. Date: May 6, 2010

(54) AUTO-SAMPLER

(75) Inventor: Yoshiaki MAEDA, Kyoto (JP)

Correspondence Address: J C PATENTS, 4 VENTURE, SUITE 250, IRVINE, CA, 92618, US

(73) Assignee: SHIMADZU CORPORATION, Kyoto (JP)

(21) Appl. No.: 12/580,071

(22) Filed: Oct. 15, 2009

(30) Foreign Application Priority Data
Oct. 30, 2008 (JP) 2008-280399

(51) Int. Cl. G01N 1/14

(52) U.S. Cl. 73/863.83

(57) ABSTRACT

The influence of contamination or carry-over can be reduced even if a mobile phase flows in an analysis flow channel at a low flow rate. A surface of a flow channel (7a) in a needle (7) is mechanically polished, so that a surface roughness (Ra) thereof is, for example, equal to or lower than 0.2 μm. The surface of the flow channel (7a) may be polished by passing a fine wire coated with abrasive grains through a hole of the needle 7 and moving the wire reciprocally in the hole.

### CROSS-REFERENCE TO RELATED APPLICATION

This application claims the priority benefit of Japan application serial no. 2008-280399, filed on Oct. 30, 2008. The entirety of the above-mentioned patent application is hereby incorporated by reference herein and made a part of specification.

### BACKGROUND OF THE INVENTION

1. Field of the Invention

The present invention relates to a total-volume injection-type auto-sampler for using a needle to withdraw a liquid sample from a sample container and inject the total-volume of the liquid sample into an analysis flow channel of a liquid chromatograph.

2. Description of Related Art

To an auto-sampler, it is necessary procedure to clean a needle after collecting a certain sample. The cleaning process is important in order to prevent a previous sample from mixing into a next sample (contamination).

The needle is typically made of stainless steel, i.e., an alloy consisting mainly of iron. Accordingly, iron is microscopically exposed on a surface of the needle, and a certain ingredient in a sample may preferably adhere to iron due to a chemical property of iron. For example, an alkaline substance is attracted to iron on a surface of stainless steel due to a hydroxyl group of the alkaline substance. As a consequence, chemical adhesion phenomenon easily occurs. Once an ingredient of a sample adheres chemically, it is difficult to remove the ingredient even through physical cleaning with a cleanser of organic solvent. A trace amount of the ingredient may adhere to a surface of the needle even after cleaning. As such, it is possible that the ingredient mixes into a next sample when the next sample is collected, thereby causing contamination.

In order to prevent the contamination, the external surface of the needle is coated with a film of noble metal, synthetic resin, quartz, or the like, thereby preventing the chemical adhesion phenomenon (see Patent Document 1).

However, when the needle is coated with a film of noble metal, synthetic resin, quartz, or the like, bumps and cavities may be formed on the surface of the needle. In this case, even if the chemical adhesion phenomenon is prevented, liquid may enter the bumps and cavities, thereby causing contamination or carry-over. Therefore, the inventor et al. propose a solution of polishing the external surface of the needle to reduce the external surface roughness of the needle, so as to prevent the contamination or carry-over caused by the bumps and cavities on the surface of the needle (see Patent Document 2).

Patent Document 1: Japanese Laid-open Patent Publication No. 2002-228668.

Patent Document 2: Japanese Laid-open Patent Publication No. 2005-283453.

Patent Document 3: Japanese Patent No. 4155218.

Patent Document 4: Japanese Laid-open Patent Publication No. 2006-342375.

As described above, contamination or carry-over can be prevented by reducing the surface roughness of the needle. However, even if the external surface roughness of the needle is reduced, the measurement result may be influenced by contamination or carry-over if the flow rate of the mobile phase in the analysis flow channel is reduced to, for example, lower than or equal to 0.2 ml/min.

### SUMMARY OF THE INVENTION

Accordingly, the present invention is directed to an auto-sampler, so as to reduce the influence of contamination or carry-over, even if the flow rate of the mobile phase in the analysis flow channel is low.

The auto-sampler of the present invention is a total-volume injection-type auto-sampler. Total-volume injection means that a needle is mounted at a front end of a flow channel so that the needle is supported to be moveable between a sample container and a sample injection port of the analysis flow channel, and a total-volume of the sample withdrawn by the needle from the sample container is injected from the needle into the analysis flow channel through the sample injection port. The auto-sampler of the present invention is particularly applicable to low flow-rate high sensitivity measurement when a mobile phase flows in the analysis flow channel at a flow rate of lower than or equal to 0.2 ml/min. The needle has an inner diameter of, for example, about 0.4 mm. Since the total-volume injection involves high pressure, the needle has a constant thickness of, for example, about 0.3 mm (and thus has an outer diameter of about 1.0 mm). It is difficult to fabricate the metal needle having small inner and outer diameters by a method of forming a hole at the center of a cylinder having an outer diameter of 1.0 mm by machining. Therefore, the metal needle is generally formed by performing the following steps repeatedly, that is, applying a force to extrude a tubing having large inner and outer diameters with a die, followed by annealing of the hardened tubing.

The inventor found that for high sensitivity measurement at a low injection flow rate, the reason why the measurement result is influenced by contamination or carry-over lies in the manufacturing method of the needle. That is, in the manufacturing method, at the stage of forming the final inner and outer diameters, a fold in the extrusion direction of the needle is often formed on a surface of a flow channel in the needle. In addition, the previously withdrawn liquid sample remains in the fold, and will be ejected along with a next liquid sample to be analyzed, thereby causing contamination or carry-over. When the liquid flows in the needle at a high flow rate, the liquid may not easily remain in the flow channel, so it doesn't become a problem. However, if the flow rate of the liquid flowing in the needle decreases, the liquid may easily remain in the flow channel, and the problem arises.

Therefore, the auto-sampler of the present invention is a total-volume injection-type auto-sampler. Total-volume injection means that a needle is mounted at a front end of a flow channel so that the needle is supported to be moveable between a sample container and a sample injection port of the analysis flow channel, and a total-volume of the sample withdrawn by the needle from the sample container is injected from the needle into the analysis flow channel through the sample injection port. The analysis flow channel is an analysis flow channel of a high-speed liquid chromatograph connected with a high-pressure column downstream of the sample injection port. An inner surface of the needle is mechanically polished. The surface of the flow channel in the needle is mechanically polished. In this manner, the fold on the surface of the flow channel in the needle generated by the manufacturing method of the fine needle becomes smooth, and the liquid sample may not easily remain in the fold. In addition, the needle with the surface of the flow channel that has been mechanically polished has a surface roughness Ra of, for example, lower than or equal to 0.2 μm.

The polishing of the inner surface of the needle is also described in Patent Document 3. As described in the document, a surface roughness ratio of a straight tube portion to a reduced-diameter portion of the needle is adjusted to facilitate the generation of turbulence in the needle, thereby improving the cleaning efficiency in the needle. Here in Document 3, the objective of polishing the inner surface of the needle is to adjust the surface roughness ratio of the straight tube portion to the reduced-diameter portion of the needle, rather than to smooth the fold in the flow channel of the needle. In addition, the document is directed to a dispenser, rather than the low flow-rate total-volume injection-type auto-sampler of the present invention. Since the dispenser ejects an object under atmospheric pressure, the dispenser does not bear any pressure.

In the total-volume injection-type auto-sampler of the present invention, since the inner surface of the needle is mechanically polished, the liquid sample is prevented from remaining in the flow channel in the needle, so that contamination or carry-over is avoided, thereby improving the analytical precision of the liquid chromatograph in low flow-rate high sensitivity measurement.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a needle of an auto-sampler according to an embodiment of the present invention.

FIG. 2 is a schematic view of main components of a flow channel in an auto-sampler for use in a liquid chromatograph according to an embodiment of the present invention.

FIG. 3 shows images of an unpolished surface of a flow channel in a needle (left) and a polished surface of a flow channel in a needle (right).

FIGS. 4(A) and 4(B) are charts illustrating roughness of the surface of the flow channel in the needle in the circumferential direction, in which FIG. 4(A) is corresponding to the needle with the flow channel having the unpolished surface, and FIG. 4(B) is corresponding to the needle with the flow channel having the polished surface.

FIG. 5 is a chromatogram obtained after a sample is injected into an analysis flow channel of the liquid chromatograph.

FIGS. 6(A) and 6(B) are chromatograms obtained by injecting a blank solution for measurement after the sample has been measured, in which FIG. 6(A) shows a condition when the needle with the flow channel having the unpolished surface is used, and FIG. 6(B) shows a condition when the needle with the flow channel having the polished surface is used.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

Embodiments are illustrated below.

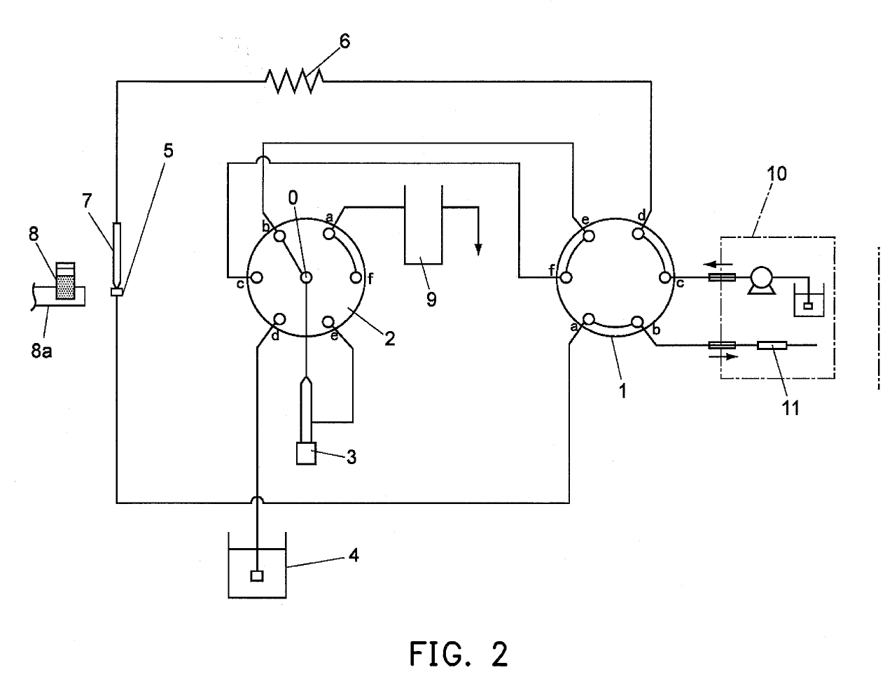

FIG. 2 is a schematic view of main components of a flow channel in an auto-sampler for use in a liquid chromatograph according to an embodiment of the present invention. Sample solutions to be analyzed are sealed in a plurality of vials (small-capacity sample bottles) 8 in advance, and are placed on a rack 8a. A needle 7 for collecting the samples from the vials 8 is connected to an injector valve 1 through a flexible loop tube 6 (hereinafter loop). The needle 7 is also supported by a drive mechanism (not shown), and is capable of moving freely between the vials 8, a cleaning port 9, and an injection port 5 in accordance with a procedure.

A valve 2 is a rotary six-position valve for switching the flow channels of the liquids to be attracted and ejected by a plunger 3. The plunger 3 is configured to move reciprocally under a mechanical force.

The injector valve 1 is connected to a liquid chromatograph apparatus 10 through tubes, and introduces a sample solution into mobile phase liquid flowing in the liquid chromatograph apparatus 10.

A process of sample injection using the analytical auto-sampler is illustrated below.

(1) The injector valve 1 is positioned so that ports e and d are in communication. The valve 2 is positioned so that ports 0 and b are in communication as shown in the figure. The needle 7 is inserted into the vial 8, and the plunger 3 is pulled to withdraw a specified amount of the sample solution. The sample solution stays inside the loop 6, and does not reach the valve 2 or the plunger 3.

(2) The needle 7 is removed from the vial 8, and moved to the injection port 5.

(3) The injector valve 1 is operated into a state shown in the figure. The sample inside the loop 6 is introduced into the flow channel of the mobile phase liquid, and then guided to a column 11. After that, render ports b and c of the injector valve 1 in direct communication, thereby initiates liquid chromatographic analysis.

(4) After the needle 7 is cleaned and moved to the vial 8 containing the sample to be analyzed next, Steps (1) to (3) above are repeated.

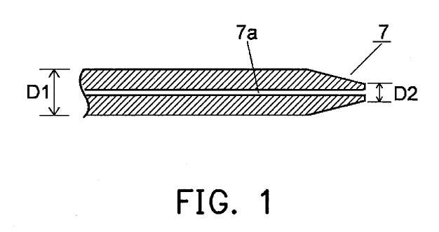

FIG. 1 is a schematic view of the needle according to this embodiment.

The needle 7 is, for example, but not limited to, a flat-head type needle with a straight tube portion having an outer diameter D1 of 1.05 mm, a flow channel 7a having an inner diameter of 0.4 mm, and a flat tip having a diameter D2 of 0.65 mm. The needle 7 is made of stainless steel, and has an external surface coated with a platinum plating layer having a thickness of several μm to several tens of μm. The surface after plating is polished so as to reduce the surface roughness. For the surface roughness, an average roughness Ra is 0.01 μm, and an average roughness Rtm of 10 points of maximum roughness is 0.1 μm. As disclosed in Patent Document 3, the objective of polishing the surface of the needle is to prevent contamination caused by the sample or a cleaning solution attached to the surface of the needle. The surface of the needle may be polished by a mechanical method using abrasive grains. In particular, the needle may be polished by hand with abrasive grains attached to a polishing cloth.

In addition, although the external surface of the needle 7 is plated and polished in this embodiment, the needle used in the auto-sampler of the present invention is not limited thereto, and may also be a needle that is neither plated nor polished.

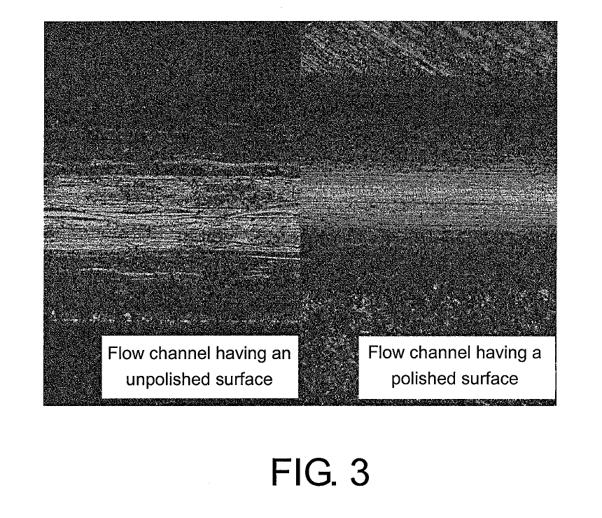

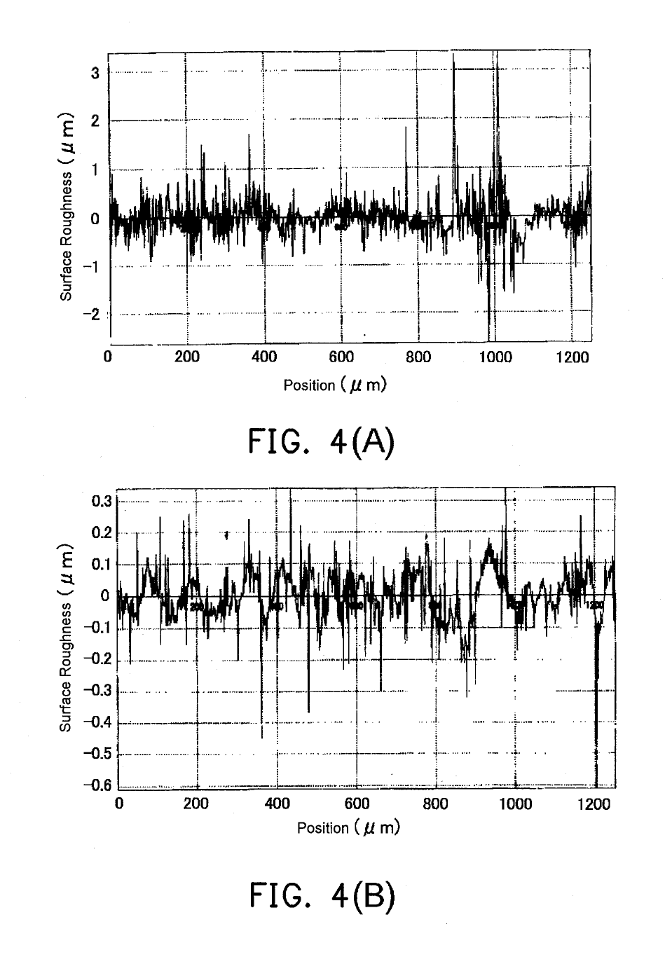

After the surface of the flow channel 7a in the needle 7 is mechanically polished, the surface roughness Ra is, for example, equal to or lower than 0.2 μm. The surface of the flow channel 7a may be polished by passing a fine wire coated with abrasive grains such as that described in Patent Document 4 through the hole of the needle 7 and moving the wire reciprocally in the hole. FIG. 3 shows images of an unpolished surface of a flow channel in a needle (left) and a polished surface of a flow channel in a needle (right). FIGS. 4(A) and 4(B) are charts illustrating roughness of the surface in the circumferential direction, in which FIG. 4(A) is corresponding to the needle with the flow channel having the unpolished surface, and FIG. 4(B) is corresponding to the needle with the flow channel having the polished surface.

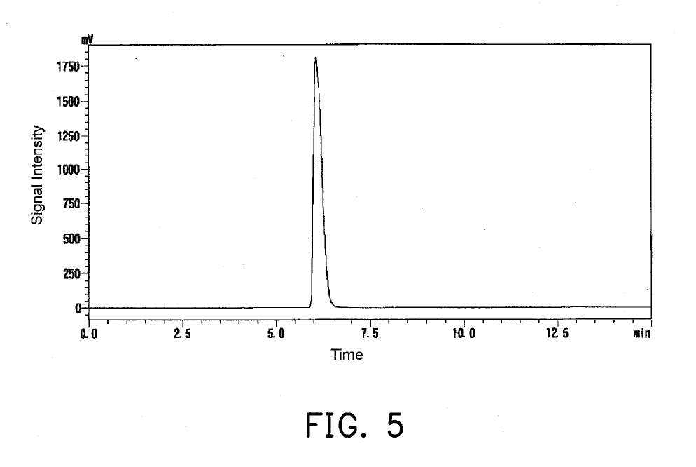

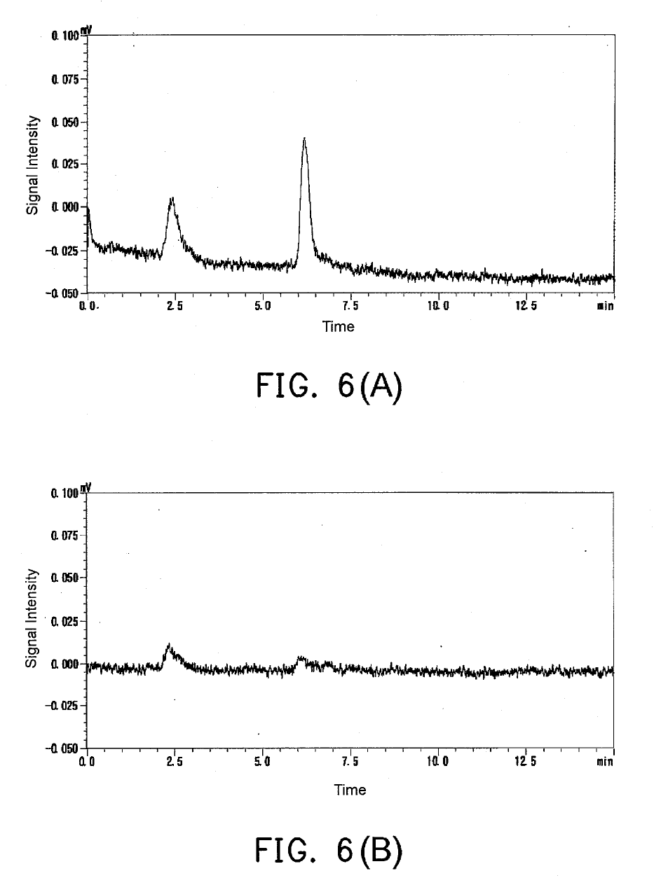

FIG. 5 is a chromatogram obtained after a sample is injected into an analysis flow channel of the liquid chromatograph. FIGS. 6(A) and 6(B) are chromatograms obtained by injecting a blank solution for measurement after the sample as shown in FIG. 5 has been measured, in which FIG. 6(A) shows a condition when the needle with the flow channel having the unpolished surface is used, and FIG. 6(B) shows a condition when the needle with the flow channel having the polished surface is used.

In addition, in the experiment, conditions of the liquid chromatograph are set as follows.

Mobile phase: water/methanol=7/3
Flow rate of the mobile phase for supplying liquid: 0.2 mL/min
Sample: 2000 mg/L solution of caffeine in water
Injection amount: 5 μL
Cleaning solution: water/methanol=7/3
Column: two XR-ODS (II) of SHIMADZU with diameter 2 mm, length 100 mm are connected in series
Column oven temperature: 40° C.
Detector wavelength: 272 nm

It can be seen by comparing FIG. 6(A) with FIG. 6(B) that, when low flow-rate high sensitivity measurement is performed under the above conditions, for the measurement using the needle with the flow channel having the unpolished surface as shown in FIG. 6(A), the previously measured sample remains in the needle, and peaks are shown; in contrast, for the measurement using the needle with the flow channel having the polished surface as shown in FIG. 6(B), the peaks like FIG. 6(A) are not detected. If a contamination rate is calculated according to the peak area, contamination of about 0.004% is detected for the measurement using the needle with the flow channel having the unpolished surface, and no contamination is detected for the measurement using the needle with the flow channel having the polished surface.

As can be seen from the above, by using the needle with the flow channel having the mechanically polished surface, the influence of contamination is lower than the situation using the conventional needle, even for low flow-rate high sensitivity measurement, thereby improving the analytical precision of the liquid chromatograph.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An auto-sampler, for using a metal needle to withdraw a sample from a sample container and inject the sample into an analysis flow channel, wherein
the auto-sampler is a total-volume injection-type auto-sampler, wherein, in a total-volume injection, the needle is mounted at a front end of a flow channel so that the needle is supported to be moveable between the sample container and a sample injection port of the analysis flow channel, and a total-volume of the sample withdrawn by the needle from the sample container is then injected from the needle into the analysis flow channel through the sample injection port;
the analysis flow channel is an analysis flow channel of a high-speed liquid chromatograph connected with a high-pressure column downstream of the sample injection port; and
an inner surface of the needle is mechanically polished.
